(19) United States
(12) Patent Application Publication
(10) Pub. No.: US 2017/0267015 A1
(43) Pub. Date: Sep. 21, 2017

(54) Marking Implement

(71) Applicant: Lani J. Daniels, JR., St. Petersburg, FL (US)

(72) Inventor: Lani J. Daniels, JR., St. Petersburg, FL (US)

(21) Appl. No.: 15/073,994

(22) Filed: Mar. 18, 2016

(51) Int. Cl. B43K 23/012; A46B 9/00; B43K 27/00; A46B 5/04; B43K 19/02; B43K 8/02

(52) U.S. Cl. CPC B43K 23/012; B43K 19/02; B43K 8/024; B43K 8/022; B43K 27/00; A46B 5/04; A46B 9/005

(57) ABSTRACT

A marking implement has a body that has a marking device on one side of the body. The marking device is designed for leaving a mark on a surface. On a distal second side of the body is a strap or straps for removably affixing the body to an appendage/digit of a user (e.g., a single finger or fingers) so the marking implement does not require pressure from another appendage of the user to work. Movement of the marking device across a surface deposits a mark on the surface such as a pen line pencil line, highlighter line, strip of pain, ink line.

### FIELD

This invention relates to the field of writing and more particularly to a device for writing using a single digit or other appendage.

### BACKGROUND

There are many circumstances when the use of a standard pen, pencil, paint brush, or other writing system is difficult or less desirable to use. For example, after writing several pages, some people develop cramps in their hands to the point where they can no longer write making it less desirable to write with such instruments. Other times such instruments are less useful when the person writing has difficulty holding and/or maneuvering a pen, pencil, paint brush, etc. In particular, using a pen/pencil/paintbrush is difficult or impossible for those with certain disabilities such as the loss of one or more fingers and for those who are very young and/or have coordination and control difficulties. Imagine trying to write a page of notes when an accident has left you with only one finger.

Existing writing instruments are typically elongated shafts having a marking device at an end of the elongated shaft (e.g., pen tip, pencil tip, brush . . . ). To use such writing instruments, one must position the elongated shaft between two or three fingers and hold the writing instrument steady while moving the marking device across a medium such as paper, etc. This is difficult for small children and impossible for many individuals who have difficulties with muscle movement and/or control and very difficult to impossible for those who are missing one or more fingers.

What is needed is a writing device that is useful for a range of individuals of very young age or those with various disabilities.

### SUMMARY

In one embodiment, a marking implement is disclosed including a body that has a marking device on one side of the body. The marking device is designed for leaving a mark on a surface. On a distal second side of the body is a strap or straps for removably affixing the body to an appendage of a user so the marking implement does not require pressure from another appendage of the user to work. Movement of the marking device across a surface leaves a mark on the surface such as a pen line pencil line, highlighter line, strip of pain, ink line.

In another embodiment, a method of marking a surface using a single digit of a hand is disclosed including attaching a marking implement to a single digit of a hand then using the single digit to position a marking device of the marking implement on a surface. Moving of the single digit and, therefore, moving of the marking implement across the surface results in leaving a mark on the surface by the marking device. After leaving the desired mark, the marking implement is removed from the single digit.

In another embodiment, a marking implement is disclosed including a body that has a marking device for leaving a mark on one side and a strap made of a resilient material on a distal second side. The strap removably affixes the body to an appendage of a user (e.g., a finger). Movement of the marking device across a surface leaves a mark on the surface.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a marking implement being worn on a finger.

FIG. 2 illustrates a perspective view of the marking implement with a snap form of wearing.

FIG. 3 illustrates a perspective view of the marking implement with a hook/loop form of wearing.

FIG. 4 illustrates a plan view of the marking implement with interchangeable tips.

FIG. 5 illustrates a perspective view of the marking implement being used to write.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Described is a marking implement that removably attaches to, for example, a finger or other part of a person, or to any object. By removably attaching, the marking implement is donned when marking is to be performed and then removed when finished. Removal is performed without tools as would be done with a watch or ring. The term marking means any form of depositing of a material on the surface including, but not limited to, drawing, writing, smudging, painting, finger painting, highlighting, etc. The material left on the surface is often known as writing, scribbling, painting, artwork, signage, a signature, doodling, etc.

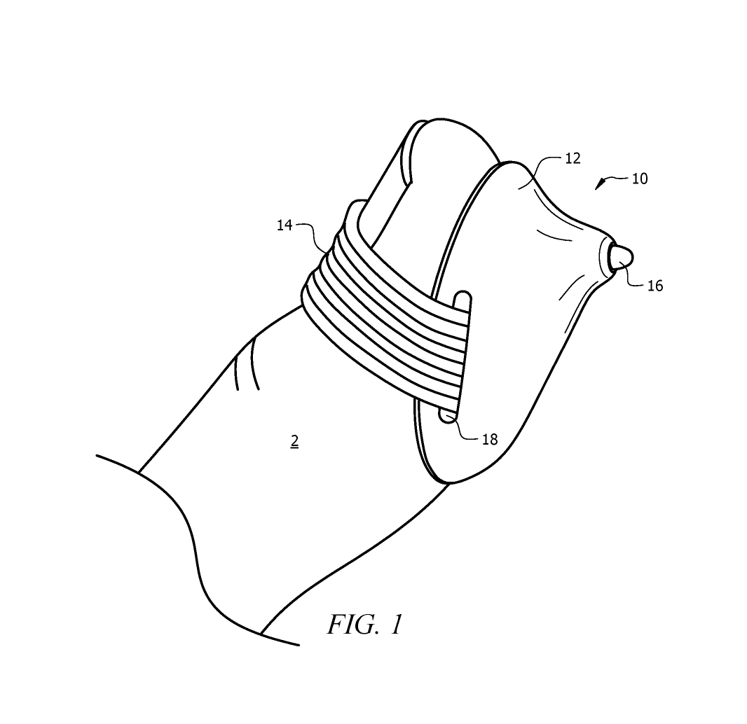

Referring to FIG. 1, a perspective view of a marking implement 10 being worn on a finger 2 is shown. In this view, the marking implement 10 is removably attached to a finger 2 by a band of resilient material 14 that is any type of resilient material as known in the industry such as a material having elastic properties or imbedded strands of elastic material, etc. In the example shown, the band of resilient material 14 passes through openings 18 in the body 12 of the marking implement 10, though any form of attachment of the band of resilient material 14 to the body 12 is anticipated, including affixing ends of the band of resilient material 14 to the body by enlarged ends, an adhesive, welding, melting or molding the body 12 around the band of resilient material 14, etc. The net results is a marking implement 10 in which, when a finger 2 is inserted into the resilient material 14, the marking implement 10 holds onto the finger 2 by resilient force of the band of resilient member 14 until another force of removal urges the marking implement 10 off of the finger 2.

On the marking implement 10, at a location distal from the band of resilient material, is a marking device 16. As will be shown, the marking device 10 is any device capable of depositing a material on a surface such as a pencil point, pen point, felt-tip marker point, crayon, chalk, paint brush, paint sponge, etc. Marking is performed by depositing the material onto the surface as lead from a pencil point, ink from a pen point, wax from a crayon, paint from a paint brush, etc.

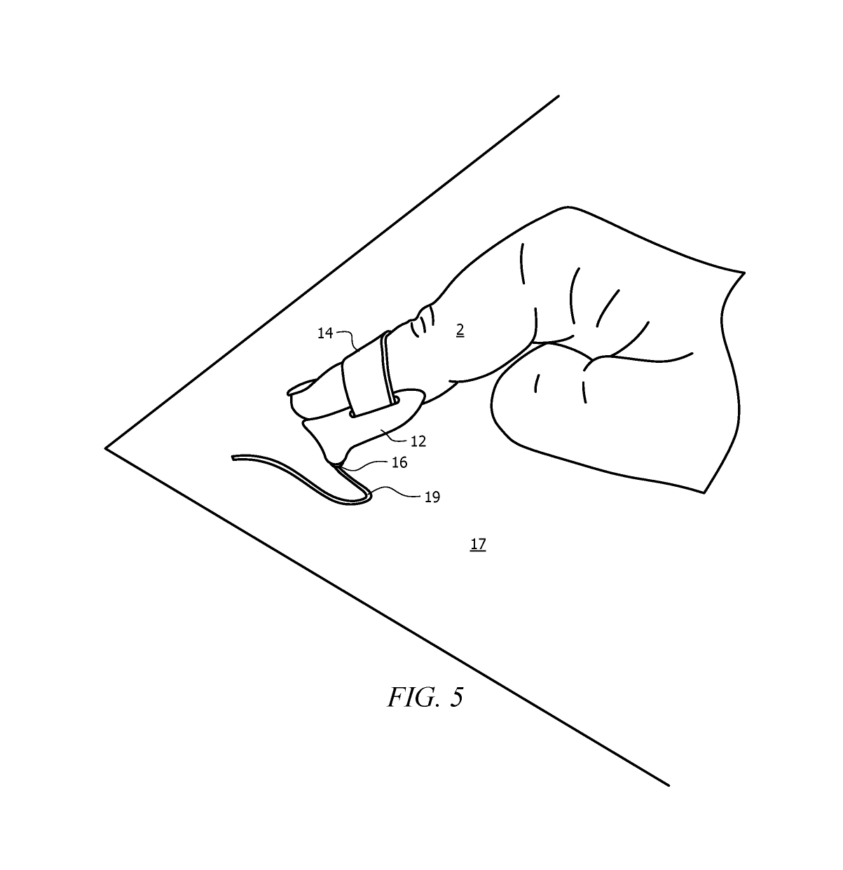

In the example shown in FIG. 1, the marking device 10 is a felt-tip marker point. As shown in FIG. 1, the marking implement 10 is removably attached to the finger 2 and ready to be used in writing, painting, or any marking activity that is normally possible with a pencil, pen, crayon, marker, chalk, finger-paints, etc. In some embodiments, the marking device 16 has an integral source of marking material such as ink, lead, paint, etc. For example, the marking device 16 has a well of ink or paint. In some embodiments, the ink/paint is refillable. In some embodiments, the marking device 16 has no integral ink/paint source and is dipped or coated with ink or paint before use. As an example of the latter, a marking device 16 is a brush and the brush is dipped into paint and then the brush transfers the paint to a surface 17 (see FIG. 5) such as a canvas, paper or a wall, etc.

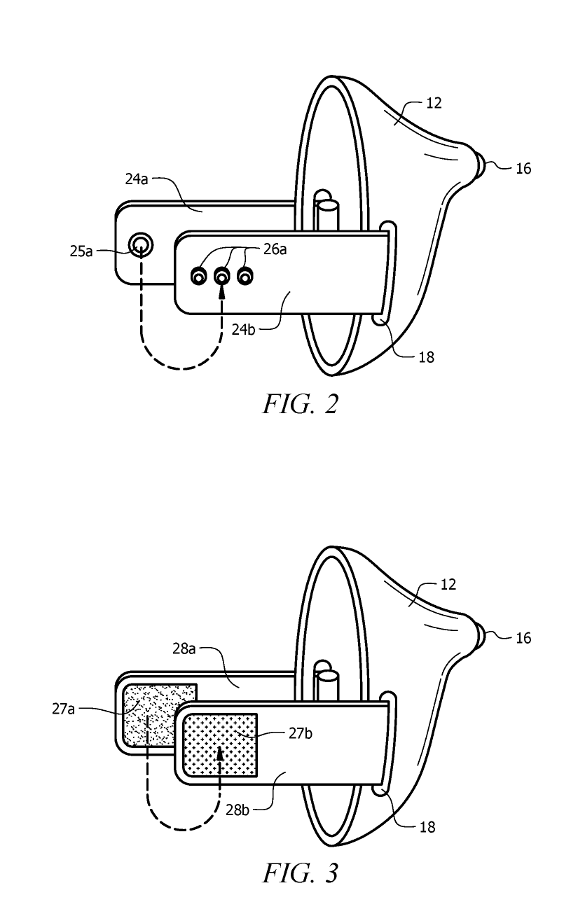

Referring to FIG. 2, a perspective view of the marking implement 10 with a snap form of engaging is shown. In this, instead of a resilient member 14, a pair of straps 24a/24b are used to hold the marking implement 10 to the finger by way of snap system. In this example, a female snap 25a mates with any of three different male snaps 26a to provide three degrees of comfort and holding strength, depending upon the diameter of the user's finger 2. Although one configuration of snaps 25a/26a is shown, any configuration, type of snaps 25a/26a, and number of snaps 25a/26a is anticipated. Further, it is equally anticipated that the straps 24a/24b are stiff, have no snaps, and at least partially curved inwardly to hold to a finger with a force of slightly bending the straps 24a/24b, as for example, a toy ring would be held on a child's finger.

Referring to FIG. 3, a perspective view of the marking implement with a hook/loop form of engaging is shown. In this, instead of a resilient member 14, a pair of straps 28a/28b is used to hold the marking implement 10 to the finger by way of hook and loop material 27a/27b. In this example, hook material 27b is on a surface of one strap 28b and loop material 27a is on a surface of the other strap 28a. The hook material 27b mates with the loop material 27a at any relative position, providing various degrees of comfort and holding strength, depending upon the diameter of the user's finger 2. Any size, shape, and/or position is anticipated for the hook material 27b and the loop material 27a.

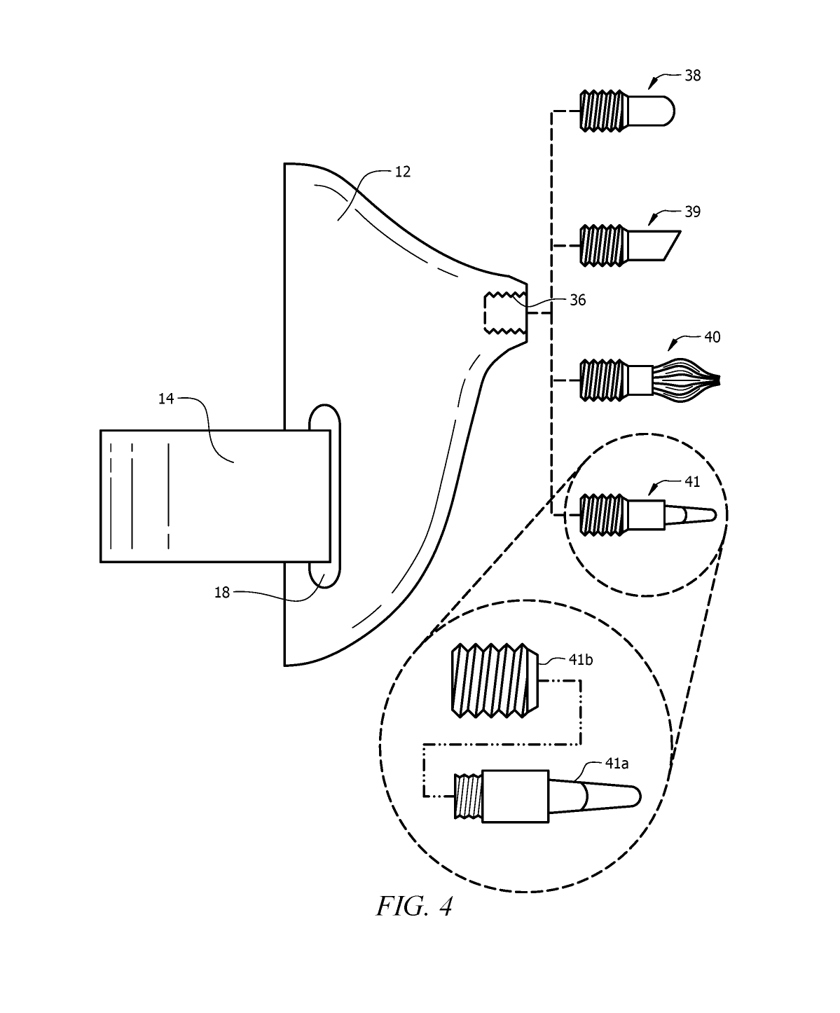

Referring to FIG. 4, a plan view of the marking implement 10 with interchangeable tips 38/39/40/41 is shown. Although it is anticipated that the marking implement 10 include a fixed tip (e.g., the fixed felt-tip 16 as shown in FIGS. 1-3, or any other fixed tip such as a paint brush, chalk, pen, pencil, magic marker, highlighter, sponge, etc.), in some embodiments, the base 12 has a threaded receiver 36 into which any available tip 38/39/40/41 is inserted as needed. Although a threaded receiver 36 is shown, any form of removable insertion is anticipated such as a snap receiver, a frictionally-held receiver, a twist-to-lock receiver, etc. In the examples shown, interchangeable tips 38/39/40/41 include a felt tip 38, a highlighter tip 39, a paint brush 40, and a crayon 41, though any type of tip is anticipated. In the removable crayon tip 41 that is shown, the crayon portion 41a (that which is typically made of a colored wax material) has threads that mate into a barrel 41b. The barrel 41b has outer threads that mate into the threaded receiver 41b. In this way, any standard crayon can be threaded into the barrel 41b by creating threads on the standard crayon as the standard crayon is rotated into the threaded receiver 41b.

Referring to FIG. 5, a perspective view of the marking implement 10 being used to write on a surface 17 is shown. The marking implement 10 is shown held to a finger 2 of a user by a band of resilient material 14. The tip 16 extends from the body 12 of the marking implement 10 and is shown leaving a mark 19 on a surface 17 (e.g., a wall, paper, canvas, etc.). Note that although a thin line 19 on a surface 17 is shown, it is anticipated that the marking implement 10 have various sizes and styles of marking devices 16, including tips 16 for finger painting, brush tips, felt tips, marker tips, highlighter tips, sponge tips, smudging, etc., for leaving any known type of mark on any surface 17 (e.g., paper, canvas, walls, model toys, etc.), not limited in any way to a particular surface 17.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A marking implement comprising:
a body;
a marking device for emitting a mark, the marking device positioned on one side of the body; and
means for removably affixing, the means for removably affixing attached to a distal second side of the body, the means for removably affixing for removably attaching the body to an appendage of a user;
whereas movement of the marking device across a surface deposits a mark on the surface.

2. The marking implement of claim 1, wherein the means for removably affixing is a strap made of a resilient material.

3. The marking implement of claim 1, wherein the means for removably affixing is a pair of straps, a first end of each of the straps connected to the body and a second end of a first one of the each of the straps having a male snap and a second end of a second of each of the straps having a female snap.

4. The marking implement of claim 1, wherein the means for removably affixing is a pair of straps, a first end of each of the straps connected to the body and a second end of a first one of the each of the straps having loop material and a second end of a second of each of the straps having hook material.

5. The marking implement of claim 1, wherein the marking device is a pen tip.

6. The marking implement of claim 1, wherein the marking device is a pencil tip.

7. The marking implement of claim 1, wherein the marking device is a felt tip.

8. The marking implement of claim 1, wherein the marking device is a crayon.

9. The marking implement of claim 1, wherein the marking device is a brush tip.

10. The marking implement of claim 1, wherein the marking device is interchangeable with other marking devices.

11. The marking implement of claim 1, wherein the marking device has an integral source of marking material.

12. A method of marking a surface using a single digit of a hand, the method comprising:
attaching a marking implement to a single digit of a hand;
using the single digit to position a marking device of the marking implement on a surface;
moving the single digit and, therefore, moving the marking implement across the surface, thereby leaving a mark on the surface by the marking device; and
removing the marking implement from the single digit.

13. The method of claim 12, wherein the marking device has an integral source of ink.

14. The method of claim 12, wherein the marking device has an external source of ink and before the step of moving, performing a step of dipping the marking device into the external source of ink.

15. A marking implement comprising:
a body;
a marking device on one side of the body, the marking device for leaving a mark on a surface; and
a strap made of a resilient material on a distal second side of the body, the strap for removably affixing the body to an appendage of a user;
whereas movement of the marking device across the surface deposits the mark on the surface.

16. The marking implement of claim 15, wherein the marking device is a pen tip.

17. The marking implement of claim 15, wherein the marking device is a felt tip.

18. The marking implement of claim 15, wherein the marking device is a sponge for absorbing finger paints.

19. The marking implement of claim 15, wherein the marking device is a brush tip.

20. The marking implement of claim 15, wherein the marking device is interchangeable with other marking devices.
